(19) United States
(12) Patent Application Publication
(10) Pub. No.: US 2025/0095137 A1
(43) Pub. Date: Mar. 20, 2025

(54) IMAGE PROCESSING APPARATUS, IMAGE PROCESSING METHOD, AND NON-TRANSITORY COMPUTER-READABLE STORAGE MEDIUM STORING COMPUTER PROGRAM

(71) Applicant: CANON KABUSHIKI KAISHA, Tokyo (JP)

(72) Inventor: TOSHIYUKI ISHII, Tokyo (JP)

(21) Appl. No.: 18/829,045

(22) Filed: Sep. 9, 2024

(30) Foreign Application Priority Data
Sep. 20, 2023 (JP) 2023-153906

(51) Int. Cl. G06T 7/00; G06T 5/40; G06T 5/50; G06T 5/70; H04N 1/00

(52) U.S. Cl. CPC G06T 7/001; G06T 5/40; G06T 5/50; G06T 5/70; H04N 1/00037; H04N 1/00045; G06T 2207/10008; G06T 2207/10024; G06T 2207/30144

(57) ABSTRACT

An image processing apparatus comprising: a reference image acquisition unit configured to acquire a reference image as a reference of inspection of a printed product; a read image acquisition unit configured to acquire a read image obtained by reading the printed product; a correction unit configured to correct a color of a first region using a first correction condition and correct a color of a second region using a second correction condition in the reference image and the read image; and an inspection unit configured to inspect the printed product based on the color of the first region corrected using the first correction condition and the color of the second region corrected using the second correction condition.

### BACKGROUND OF THE INVENTION

### Field of the Invention

The present invention relates to an image processing apparatus, an image processing method, and a non-transitory computer-readable storage medium storing a computer program.

### Description of the Related Art

A printed product output from a printing apparatus sometimes has a defect caused by a stain arising from attachment of a coloring material in ink, toner, or the like to an unintended portion, or a defect caused by a color loss arising from a failure of attachment of a sufficient amount of a coloring material to a portion where an image should be formed. As a system for inspecting the presence/absence of these print defects, there is provided, for example, a printing inspection system for reading a printed product output from a printing apparatus by a line sensor of a camera or a scanner, or the like, and automatically inspecting, based on a read image, whether printing is successfully executed. Such a printing inspection system can detect the presence/absence of a print defect on a printed product as an inspection target based on a difference between a reference image representing image data of a defect-free printed product and a read image representing image data of a printed product as an inspection target. The printing inspection system can adjust the sensitivity (for example, a threshold of the contrast or size of a defect to be detected) at which a defect is inspected. However, since an inspection result largely changes depending on the adjustment value of an inspection level, it is necessary to appropriately adjust the inspection level in order to obtain a desired inspection result. For example, Japanese Patent No. 6241121 proposes a method of adjusting an inspection level by outputting an image with a defect created in a pseudo manner and confirming an inspection result.

However, in the technique described in Japanese Patent No. 6241121, it is necessary to confirm a defect to be actually detected and decide a parameter in accordance with the inspection level. Therefore, in the technique described in Japanese Patent No. 6241121, setting of a parameter for inspecting a printed product is cumbersome.

The present invention reduces cumbersome setting of a parameter for inspecting a printed product.

### SUMMARY OF THE INVENTION

According to one aspect of the present disclosure, there is provided an image processing apparatus comprising: a reference image acquisition unit configured to acquire a reference image as a reference of inspection of a printed product; a read image acquisition unit configured to acquire a read image obtained by reading the printed product; a correction unit configured to correct a color of a first region using a first correction condition and correct a color of a second region using a second correction condition in the reference image and the read image; and an inspection unit configured to inspect the printed product based on the color of the first region corrected using the first correction condition and the color of the second region corrected using the second correction condition.

According to another aspect of the present disclosure, there is provided an image processing apparatus comprising: a reference image acquisition unit configured to acquire a reference image as a reference of inspection of a printed product; a read image acquisition unit configured to acquire a read image obtained by reading the printed product; a correction unit configured to correct colors of the reference image and the read image using a first correction condition and a second correction condition; and an inspection unit configured to inspect the printed product based on the colors of the reference image and the read image corrected using the first correction condition and the colors of the reference image and the read image corrected using the second correction condition.

According to another aspect of the present disclosure, there is provided an image processing method comprising: acquiring a reference image as a reference of inspection of a printed product; acquiring a read image obtained by reading the printed product; correcting a color of a first region using a first correction condition and correct a color of a second region using a second correction condition in the reference image and the read image; and inspecting the printed product based on the color of the first region corrected using the first correction condition and the color of the second region corrected using the second correction condition.

According to another aspect of the present disclosure, there is provided an image processing method comprising: acquiring a reference image as a reference of inspection of a printed product; acquiring a read image obtained by reading the printed product; correcting colors of the reference image and the read image using a first correction condition and a second correction condition; and inspecting the printed product based on the colors of the reference image and the read image corrected using the first correction condition and the colors of the reference image and the read image corrected using the second correction condition.

According to another aspect of the present disclosure, there is provided a non-transitory computer-readable storage medium storing a computer program for causing, when loaded and executed by a computer, the computer to: acquire a reference image as a reference of inspection of a printed product; acquire a read image obtained by reading the printed product; correct a color of a first region using a first correction condition and correct a color of a second region using a second correction condition in the reference image and the read image; and inspect the printed product based on the color of the first region corrected using the first correction condition and the color of the second region corrected using the second correction condition.

According to another aspect of the present disclosure, there is provided a non-transitory computer-readable storage medium storing a computer program for causing, when loaded and executed by a computer, the computer to: acquire a reference image as a reference of inspection of a printed product; acquire a read image obtained by reading the printed product; correct colors of the reference image and the read image using a first correction condition and a second correction condition; and inspect the printed product based on the colors of the reference image and the read image corrected using the first correction condition and the colors of the reference image and the read image corrected using the second correction condition.

Further features of the present invention will become apparent from the following description of exemplary embodiments (with reference to the attached drawings).

### BRIEF DESCRIPTION OF THE DRAWINGS

FIG. 1 is a view showing the configuration of a printing inspection system;

FIG. 2 is a block diagram showing the functional configuration of an image processing apparatus;

FIG. 3 is a flowchart illustrating the procedure of an image processing method;

FIG. 4 is a view showing an example of a UI displayed on a display unit;

FIG. 5 is a flowchart illustrating the procedure of processing in step S15;

FIG. 6 is a flowchart illustrating the procedure of processing in step S16;

FIG. 7 is a flowchart illustrating the procedure of processing in step S16 according to the second embodiment;

FIG. 8 is a flowchart illustrating the procedure of an image processing method according to the third embodiment;

FIG. 9 is a flowchart illustrating the procedure of processing in step S368 according to the third embodiment; and

FIG. 10 is a view showing an example of a UI displayed on a display unit according to other embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

An image processing apparatus according to the first embodiment divides an inspection image into regions in accordance with a luminance value, and determines the presence/absence of a defect on a printed product using an image obtained by correcting the luminance value for each region. In a case where an inspection image includes a low-luminance region, a defect in the low-luminance region is hardly detected since the contrast of the defect decreases, as compared with defects in an intermediate-luminance region and a high-luminance region (to be referred to as an intermediate/high-luminance region hereinafter). Therefore, the image processing apparatus corrects the luminance value for each region in order to detect defects by the same detection parameter in the low-luminance region and the intermediate/high-luminance region.

### (Configuration of Printing Inspection System)

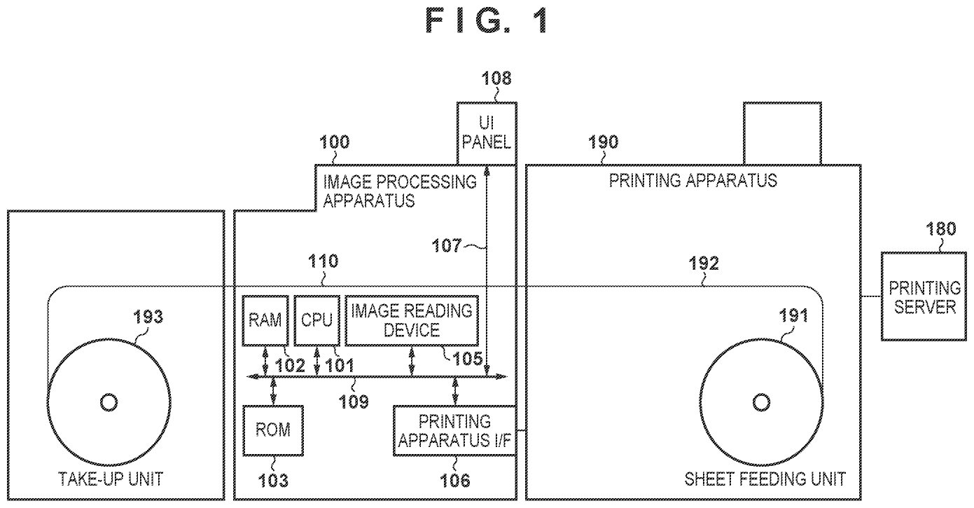

FIG. 1 is a view showing the overall configuration of a printing inspection system that includes an image processing apparatus 100 and outputs and inspects a printed product according to the first embodiment. The printing inspection system according to the first embodiment includes the image processing apparatus 100 and a printing apparatus 190. The printing inspection system according to the first embodiment may further include a printing server 180.

The printing server 180 generates a print job including a document to be printed, and inputs the print job to the printing apparatus 190. The printing apparatus 190 is an apparatus that forms an image on a roll sheet based on the print job input from the printing server 180, and a sheet feeding unit 191 stores the roll sheet. When the print job is input, the printing apparatus 190 forms an image while conveying the roll sheet stored in the sheet feeding unit 191 along a conveyance path 192, and then conveys the roll sheet to the image processing apparatus 100.

The image processing apparatus 100 inspects a defect on an inspection target medium having undergone printing. The inspection target medium is obtained by forming an image on the print medium by the printing apparatus 190, and is conveyed through the conveyance path 192 inside the printing apparatus 190. The image processing apparatus 100 may incorporate a CPU 101, a RAM 102, and a ROM 103. The image processing apparatus 100 may include an image reading device 105, a printing apparatus interface (I/F) 106, a general-purpose interface (I/F) 107, a user interface (to be referred to as a UI hereinafter) panel 108, and a main bus 109. Furthermore, the image processing apparatus 100 may have a conveyance path 110 for a print medium that is connected to the conveyance path 192 of the printing apparatus 190. The roll sheet passes through the image processing apparatus 100 after passing through the printing apparatus, and is taken up by a take-up unit 193 to be stored as a printed roll sheet.

The image processing apparatus according to each embodiment to be described later can be implemented by a computer including a processor and a memory. For example, the function of each unit can be implemented when, for example, a processor such as the CPU 101 executes a program stored in a memory such as the RAM 102 or the ROM 103. The processor such as the CPU 101 can also control each module in the image processing apparatus 100, as needed. Note that the image processing apparatus according to the embodiment of the present invention may be constituted by, for example, a plurality of processing apparatuses connected via a network.

The CPU 101 is a processor that controls each unit in the image processing apparatus 100. The RAM 102 temporarily holds an application executed by the CPU 101, data used for image processing, or the like. The ROM 103 stores programs executed by the CPU 101.

The image reading device 105 scans and reads, on the conveyance path 110, a print medium sent from the printing apparatus 190, and obtains data as image data. Since the conveyance path 110 serves as a background when the image reading device 105 reads an image on the print medium, it can be constituted to have a color (for example, black) easily discriminable from the print medium on the image. The printing apparatus I/F 106 is connected to the printing apparatus 190, and the image processing apparatus 100 can communicate with the printing apparatus 190 via the printing apparatus I/F 106. For example, the image processing apparatus 100 and the printing apparatus 190 can be synchronized via the printing apparatus I/F 106 to notify each other of their operating statuses.

The UI panel 108 can output information to the user. The UI panel 108 may be a display device such as a liquid crystal display and can function as the user interface of the image processing apparatus 100. The UI panel 108 can notify the user of, for example, the current status or settings of the image processing apparatus 100. The UI panel 108 may include an input device such as a touch panel or a button and can accept an instruction from the user. The main bus 109 is a transmission path that connects the modules of the image processing apparatus 100.

The image processing apparatus 100 performs inspection processing to check the presence/absence of a defect on a print medium based on image data of the print medium acquired by the image reading device 105 while the print medium output from the printing apparatus 190 is conveyed along the conveyance path 110. A determination result of the inspection processing is held in the RAM 102 or the ROM 103. Note that this embodiment has explained the configuration of the printing inspection system intended for a roll sheet but a system configuration intended for a cut sheet may be used. In the case of a cut sheet, an output tray to which a print medium determined, by inspection, to be accepted is output and an output tray to which a print medium determined to be rejected is output may be provided. In this case, the output trays are connected to the CPU 101 via the main bus 109, and the conveyance destination of the print medium is set to one of the output trays in accordance with an inspection result.

### (Functional Configuration of Image Processing Apparatus)

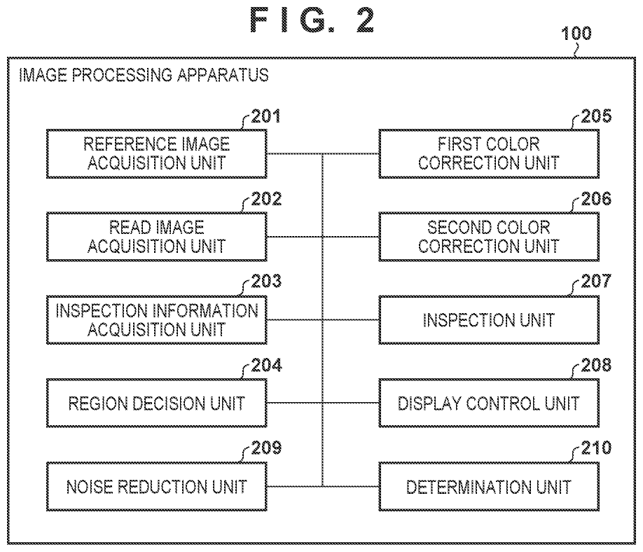

The function of the image processing apparatus 100 will be described. FIG. 2 is a block diagram showing the functional configuration of the image processing apparatus 100 according to this embodiment. The image processing apparatus 100 includes a reference image acquisition unit 201, a read image acquisition unit 202, an inspection information acquisition unit 203, a region decision unit 204, a first color correction unit 205, a second color correction unit 206, an inspection unit 207, a display control unit 208, a noise reduction unit 209, and a determination unit 210. For example, when the CPU 101 reads out a program stored in the ROM 103 and deploys it in the RAM 102, the image processing apparatus 100 may implement each of the functions of the reference image acquisition unit 201, the read image acquisition unit 202, the inspection information acquisition unit 203, the region decision unit 204, the first color correction unit 205, the second color correction unit 206, the inspection unit 207, the display control unit 208, the noise reduction unit 209, and the determination unit 210. The first color correction unit 205 and the second color correction unit 206 are examples of a correction means.

The reference image acquisition unit 201 reads out document data as original data of a printed product into the RAM 102 and performs correction processing (to be described later) for the document data, thereby acquiring a reference image. Note that in this embodiment, an image obtained by performing correction processing (to be described later) for the document data is acquired as a reference image, but an image generated based on a read image of a print medium having undergone printing by the printing apparatus 190 based on the document data may be acquired as a reference image. The read image acquisition unit 202 acquires a read image of the print medium having undergone printing by the printing apparatus 190. The acquired image data is held in the RAM 102. In this embodiment, the read image acquisition unit 202 acquires image data obtained by reading the print medium on the conveyance path 110 by the image reading device 105.

The inspection information acquisition unit 203 acquires information concerning an inspection job and an inspection level associated with inspection information setting based on a user operation or the like acquired via the UI panel 108. The region decision unit 204 decides a region where color information of the images acquired by the reference image acquisition unit 201 and the read image acquisition unit 202 is corrected.

The first color correction unit 205 performs color correction processing for the inspection image using a first color correction condition. The second color correction unit 206 performs color correction processing for the inspection image using a second color correction condition different from the first color correction condition.

The inspection unit 207 compares the reference image and the read image having undergone correction by the first color correction unit 205 and the second color correction unit 206, and determines the presence/absence of a defect based on the compared data. The display control unit 208 displays, on the UI panel 108, a UI for notifying the user of information or prompting the user to input information necessary for processing.

The noise reduction unit 209 executes noise reduction processing for a pixel with a noise amount larger than a noise threshold. The determination unit 210 determines which of the first color correction unit 205 and the second color correction unit 206 is used to perform correction for a correction target pixel. The determination unit 210 determines whether correction is complete for all the pixels of the inspection image.

### (Processing Executed by Image Processing Apparatus)

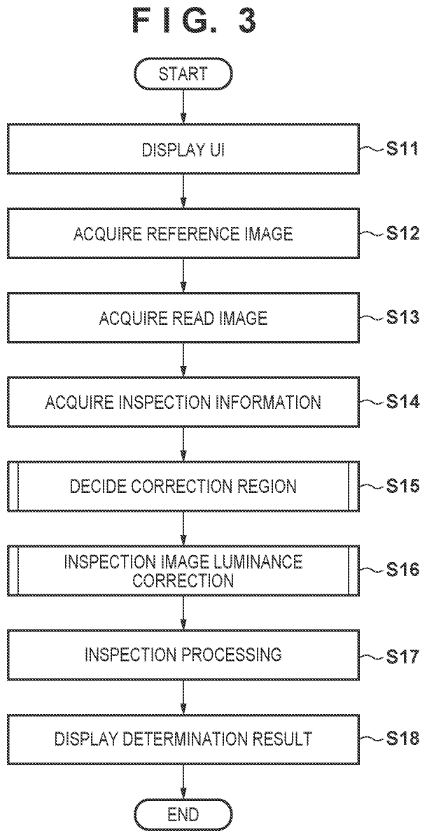

Processing executed by the image processing apparatus 100 according to this embodiment will be described below. FIG. 3 is a flowchart illustrating the procedure of an image processing method executed by the image processing apparatus 100.

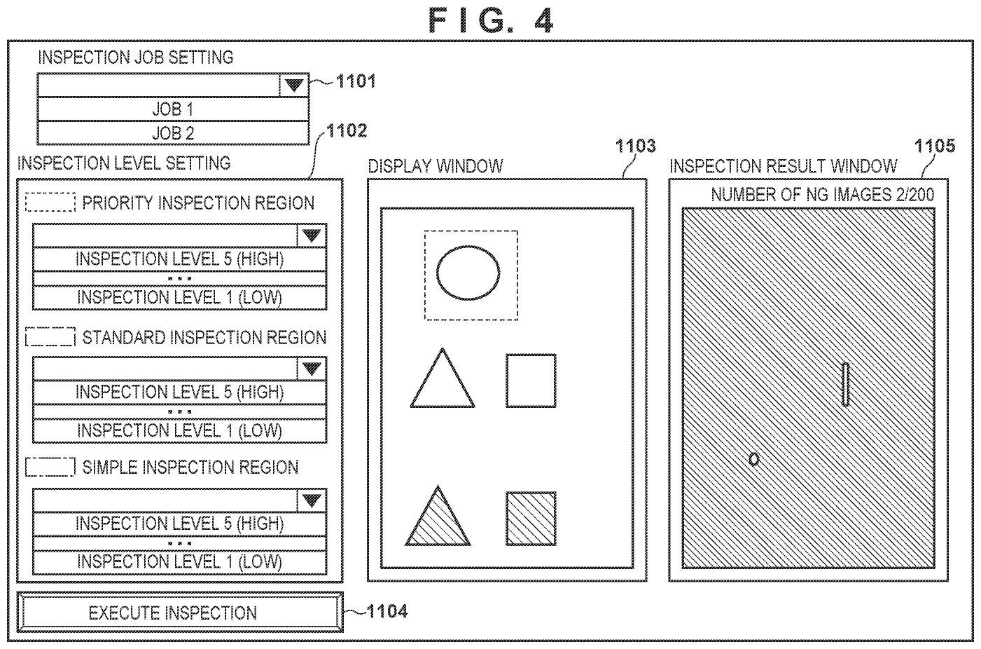

In step S11, to prompt the user to input information necessary for inspection, the display control unit 208 of the image processing apparatus 100 displays, on the UI panel 108, a UI screen for accepting an instruction from the user. The UI screen is a screen for acquiring information concerning an inspection job and an inspection level based on a user operation or the like. FIG. 4 exemplifies the UI displayed in step S11.

Referring to FIG. 4, an inspection job setting button 1101 is a button for setting information of an inspection job obtained by associating a print job for managing image data and sheet information used for inspection with information concerning the setting of the inspection level. The user presses the inspection job setting button 1101 to designate an inspection job created/registered in advance. The designated inspection job is held in the RAM 102.

An inspection level setting portion 1102 is a screen for setting an inspection level to be used for inspection. The user selects an inspection level from a pull-down menu, and the selected value is held in the RAM 102.

A display window 1103 is a window for displaying an image to be used for inspection, and the user can set an inspection level for each region while viewing the displayed image. In this embodiment, it is possible to designate three regions of a priority inspection region, a standard inspection region, and a simple inspection region as inspection regions, and the user can designate each region by a mouse operation or a touch panel operation. If no region is designated, inspection is performed at an inspection level designated for the standard inspection region. In accordance with the size and contrast of a defect to be detected, each inspection level is associated with a processing parameter necessary to detect the defect, and a defect is detected in accordance with the inspection level selected by the user. Note that in this embodiment, five inspection levels are held. As the inspection level is higher, a defect having lower contrast and a smaller size is detected, and as the inspection level is lower, a defect having high contrast and a large size is detected. In this embodiment, three kinds of inspection regions and five inspection levels are held. However, other setting numbers may be held and set.

An inspection execution button 1104 is a button for executing inspection processing. When the inspection execution button 1104 is pressed, inspection processing is executed based on the information set by the inspection job setting button 1101 to the display window 1103. The type of the defect, position information of the defect on a roll sheet, and the like determined by the inspection processing are held in the RAM 102.

An inspection result window 1105 is a window for displaying a defect map representing defect information of the inspection image and a result of determining the number of NG images. The information concerning the type and position of the detect detected by the inspection processing is displayed on the inspection result window 1105 together with the corresponding image region.

In step S12, the reference image acquisition unit 201 acquires, as a reference image, an image obtained by performing correction processing for document data, and stores it in the RAM 102. If an image generated based on a read image is used as a reference image, the reference image acquisition unit 201 acquires a read image obtained by reading an image on a roll sheet on the conveyance path 110 by the image reading device 105, and stores it in the RAM 102. In this embodiment, an image expressed by 8 bits for each of R, G, and B is used as the read image but an image expressed by 16 bits for each of R, G, and B may be used. Note that the image reading device 105 generates a read image by reading an image on a roll sheet but the reference image acquisition unit 201 may use, as a reference image, an image acquired from another apparatus. For example, a read image obtained by an apparatus different from the image reading device 105 may be stored in an auxiliary storage device (not shown). In this case, the read image acquisition unit 202 may acquire the read image from the auxiliary storage device, and generate a reference image.

Alternatively, if the document data is used as a reference image, overdetection occurs due to differences in image characteristics from the read image, and thus the reference image acquisition unit 201 performs correction processing for the document data with respect to a color reproduction characteristic and a fine line reproduction characteristic as image characteristics. In the color reproduction correction processing, the reference image acquisition unit 201 creates and holds, in advance, for the characteristic of the printing apparatus, a sheet, and an output condition, a lookup table (LUT) in which the correspondence for converting 4-channel CMYK data into 3-channel RGB data as read image data is described, and executes correction with reference to this LUT. In the fine line correction processing, the reference image acquisition unit 201 outputs and reads a fine line chart in advance, and calculates correction data concerning fine line reproduction of the read image and the document data. The reference image acquisition unit 201 calculates a filter coefficient for matching a line width with that of the read image based on the line profile of the fine line and a filter coefficient for correcting a blur of an edge at the time of scanning. The reference image acquisition unit 201 generates a reference image by applying these two kinds of correction processes to the document data. The reference image acquisition unit 201 performs processing of converting the resolution of the document data in accordance with the image size and resolution of the read image used at the time of inspection.

In step S13, the read image acquisition unit 202 acquires the read image obtained by reading the image on the roll sheet on the conveyance path 110 by the image reading device 105, and stores it in the RAM 102.

In step S14, the inspection information acquisition unit 203 acquires the inspection job set by the inspection job setting button 1101 and the inspection level set in the inspection level setting portion 1102, by the user, as inspection information via the UI panel 108.

In step S15, when correcting the color information of the reference image and the read image, the region decision unit 204 decides a region to be applied with correction of the first color correction unit 205 (to be described later) and a region to be applied with correction of the second color correction unit 206 (to be described later). The processing of the region decision unit 204 will be described in detail later.

In step S16, the image processing apparatus 100 executes color correction of the reference image and the read image based on the correction regions decided in step S15. The processing of the image processing apparatus 100 in step S16 will be described in detail later.

In step S17, the inspection unit 207 inspects the presence/absence of a defect using the reference image and read image corrected in step S16. The inspection unit 207 aligns the reference image and the read image, calculates a difference between the images, and determines, as a defective pixel, a pixel in which the calculated difference is larger than a predetermined inspection threshold. For example, the inspection unit 207 may hold, for each inspection level, an inspection threshold of contrast with respect to the difference, and a dot size and a line size with respect to a size, and determine the presence/absence of a dot defect and a line defect based on the shape size and the contrast with respect to the difference.

In step S18, the display control unit 208 displays the result processed in step S17 on the inspection result window 1105. If a defect is detected, an image of a defect map or an enlarged image of a defect map is displayed on the inspection result window 1105. The defect map is a map representing, in a case where there is a defect, the position of the defect. The defect map is an image file having the same vertical and horizontal sizes as those of the reference image and the read image. If there is a defect, the inspection unit 207 stores pixel values of RGB=(255, 255, 255) in association with the coordinate position of the corresponding defect. If there is no defect, the inspection unit 207 stores pixel values of RGB=(0, 0, 0) in association with the coordinate position of the defect. If there is no defect, the inspection unit 207 sets the pixel values to 0 and stores them. If there is a dot defect, the inspection unit 207 stores pixel values of RGB=(255, 0, 0) in association with the coordinate position. If there is a line defect, the inspection unit 207 stores pixel values of RGB=(0, 255, 0) in association with the coordinate position. Note that the inspection unit 207 may store pixel values different from the above-described pixel values in association with the coordinate position.

### <Operation of Region Decision Unit 204 in Step S15>

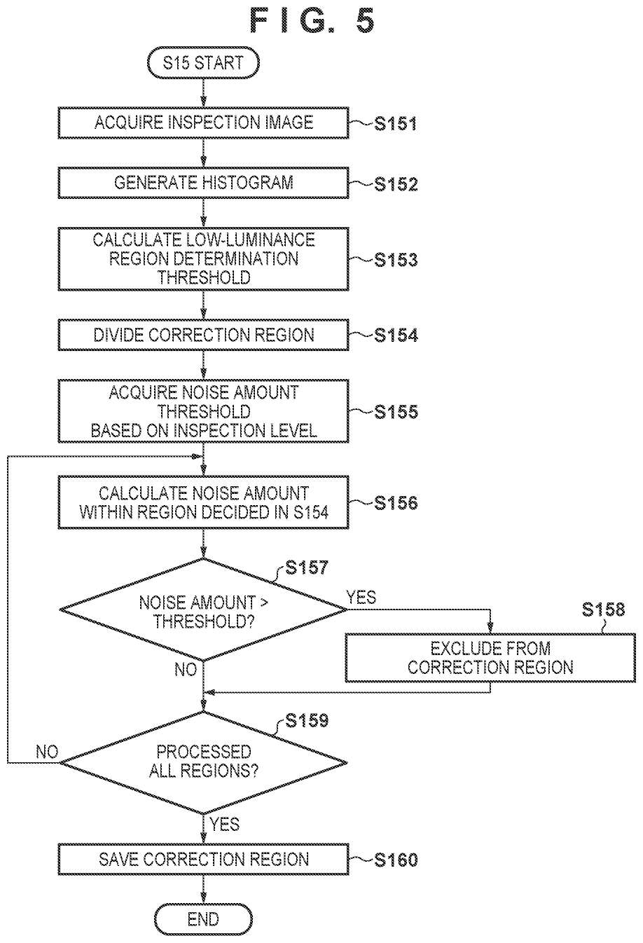

Details of the processing in step S15 will be described. FIG. 5 is a flowchart concerning the processing in step S15 by the region decision unit 204.

In step S151, the region decision unit 204 acquires an inspection image including the reference image and the read image respectively acquired in steps S12 and S13.

In step S152, the region decision unit 204 generates a histogram based on the pixel values of each of the reference image and the read image. Note that the region decision unit 204 generates a histogram concerning luminance values to divide the correction region of the image into a low-luminance region and an intermediate/high-luminance region other than the low-luminance region. The luminance value is an example of the pixel value. A pixel in the low-luminance region is an example of a first pixel, and a pixel in the intermediate/high-luminance region is an example of a second pixel. The region decision unit 204 uses pixel values of the G channel as a histogram concerning luminance values but may use the weighted averages of the respective pixel values of R, G, and B as a histogram. A lookup table (LUT) may hold, in advance, the correspondence between a scan image and the luminance measurement value of the print medium. In this case, the region decision unit 204 may generate a histogram concerning the luminance values with reference to the LUT.

In step S153, the region decision unit 204 calculates a determination threshold of the luminance value to divide the image region into a low-luminance region and an intermediate/high-luminance region based on the histogram created in step S152. For example, the region decision unit 204 calculates the average value of upper 1% of the pixel values of the histogram, and uses ¼ of the average value as the determination threshold. The region decision unit 204 may use, as the determination threshold, another value such as ⅕ of the average value obtained from upper 5% of the pixel values of the histogram. The region decision unit 204 may calculate, in advance, as a reference value, a luminance value that decreases the detection accuracy of a defect, and set the reference value of the luminance value as the determination threshold. The region decision unit 204 sets the determination threshold based on the histogram but may detect a paper white region of the sheet without using the histogram, and calculate ¼ of the average value of the pixel values of the paper white region as the determination threshold. In this case, the region decision unit 204 may skip the step of generating the histogram in step S152. The region decision unit 204 may calculate the determination threshold using not only the average value but also another statistic value such as a median or a mode.

In step S154, the region decision unit 204 divides the image acquired in step S151 into a low-luminance region and an intermediate/high-luminance region based on the determination threshold calculated in step S153. The region decision unit 204 prepares an image file having the same vertical and horizontal sizes as those of the reference image and the read image. In the image file, the region decision unit 204 embeds a pixel value of 1 in pixels in the low-luminance region where the luminance value is lower than the determination threshold or the luminance value is equal to or lower than the determination threshold, and embeds a pixel value of 0 in pixels in the intermediate/high-luminance region other than the pixels in the low-luminance region. Note that whether the luminance value satisfies a requirement with respect to the determination threshold is an example of a determination requirement. Thus, the region decision unit 204 creates a correction region determination map to be used to determine the correction region.

In step S155, the region decision unit 204 acquires the set value of the inspection level set in the inspection level setting portion 1102, and acquires a noise threshold for determining a noise amount based on the inspection level. If an image includes noise exceeding the predetermined noise threshold in luminance value correction processing (to be described later), noise may be over-detected although there is no defect as a result of correcting the luminance values. Therefore, the region decision unit 204 performs processing of excluding, from the correction region, a pixel with a noise amount exceeding the predetermined noise threshold. In this embodiment, as the inspection level of a defect is higher, smaller contrast is detected. Therefore, the region decision unit 204 sets the noise threshold of the noise amount smaller as the inspection level is higher, and sets the noise threshold of the noise amount larger as the inspection level is lower.

In step S156, the region decision unit 204 calculates a noise amount for each pixel in the correction region decided in step S154. The region decision unit 204 calculates a noise amount based on a statistic value such as a standard deviation or variance for evaluating the variations of the pixel values in a predetermined window size with, as the center, each pixel determined to be in the low-luminance region in step S154. Note that the region decision unit 204 uses the standard deviation or variance of the pixel values but may calculate a Peak Signal-to-Noise Ratio (PSNR) using the reference image and the read image with respect to each pixel considered to be in the low-luminance region and use the PSNR as a noise amount.

In step S157, the region decision unit 204 compares the noise amount calculated in step S156 with the noise threshold of the noise amount acquired in step S155. If the noise amount calculated in step S156 is larger than the noise threshold, the region decision unit 204 advances to processing in step S158. If the noise amount is equal to or smaller than the noise threshold, the region decision unit 204 advances to processing in step S159.

In step S158, the region decision unit 204 excludes, from the correction region, a pixel whose noise amount is determined to be larger than the noise threshold. More specifically, the region decision unit 204 changes, with respect to a target pixel, the pixel value in the correction region determination map to a pixel value other than 0 and 1 with reference to the correction region determination map created in step S154, and excludes the pixel from the correction region.

In step S159, the region decision unit 204 determines whether processing of generating the correction region determination map has been performed for all the pixel values of the reference image and the read image. If the processing has been performed for all the pixel values, the region decision unit 204 advances to step S160. If the processing has not been performed for all the pixel values, the region decision unit 204 returns to step S156.

In step S160, the region decision unit 204 saves the correction region determination map in the RAM 102, and ends the processing.

Note that the region decision unit 204 that executes step S15 may omit the correction region decision processing based on the noise amount in steps S155 to S159, save the correction region determination map decided in step S154 in the RAM 102, and end the processing.

### <Operation of Image Processing Apparatus 100 in Step S16>

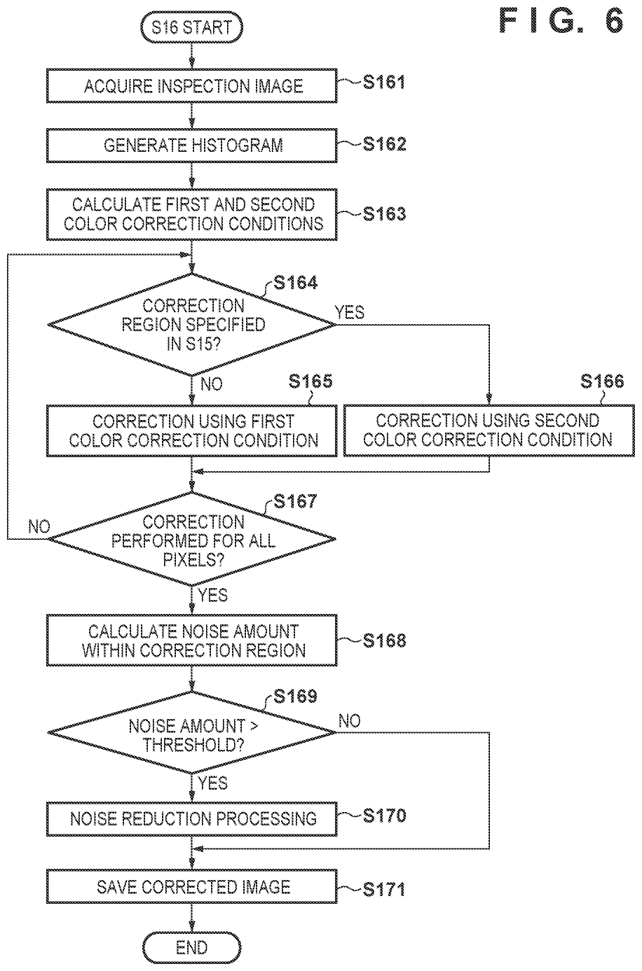

FIG. 6 is a flowchart concerning the processing of the image processing apparatus 100 in step S16. In step S16, the image processing apparatus 100 performs luminance value correction processing at a high correction degree with respect to a pixel in a region determined as the low-luminance region in step S15, and executes non-correction processing or luminance value correction processing at a low correction degree with respect to a pixel in a region determined as the intermediate/high-luminance region. The image processing apparatus 100 designs a detection parameter concerning contrast by a contrast ratio between a defect and the paper white standard of the sheet. The image processing apparatus 100 corrects the luminance values so as to detect a defect by the uniform detection parameter by correcting the pixels in the low-luminance region to the luminance value of the paper white standard regardless of the pattern (luminance values) of the inspection image.

In step S161, the region decision unit 204 acquires, as an inspection image, the reference image and the read image respectively acquired in steps S12 and S13.

In step S162, the region decision unit 204 generates a histogram based on the pixel values of each of the reference image and the read image by the same method as that described in step S152.

In step S163, each of the first color correction unit 205 and the second color correction unit 206 calculates a color correction condition used for color correction.

The first color correction unit 205 calculates a gain value gain(G) of a first color correction condition to be used for correction of the intermediate/high-luminance region by:

$$gain ( G ) = Gt / G 0 \qquad ( 1 )$$

The first color correction unit 205 uses, as G0, the average value of upper 1% of the pixel values of the histogram created in step S162. Note that instead of the average value, the first color correction unit 205 may use, as G0, another statistic value such as a mode or a median of upper 1% of the pixel values. The first color correction unit 205 uses, as Gt, the target value of the G channel when correcting the luminance value. The first color correction unit 205 holds, in advance, in the RAM 102, the target value of the G channel of the read image of paper white to be used for inspection, and then reads out this value at the time of processing and uses it as Gt. In a case where the value of G0 is a numerical value falling within the range of the value of Gt+5%, the first color correction unit 205 considers that an error from the target value is small, sets 1 in the gain value gain(G) of equation (1) as the first color correction condition, and sets a condition for performing no color correction. In a case where the value of G0 is not a numerical value falling within the range of the value of Gt+5%, the first color correction unit 205 considers that an error from the target value is large, calculates the gain value gain(G) using equation (1), and holds the calculated value as the first color correction condition in the RAM 102.

The second color correction unit 206 calculates a gain value gain_low(G) of a second color correction condition to be used for correction of the low-luminance region by:

$$gain\_low ( G ) = Gt / G 0 \_low \qquad ( 2 )$$

The second color correction unit 206 uses, as G0_low, the average value of lower 10% of the pixel values of the histogram created in step S162. Gt is the same as Gt of equation (1). Instead of the average value of lower 10%, the second color correction unit 206 may use, as G0_low, another statistic value such as a mode or a median, or may use the numerical value of not lower 10% but lower 5%. As will be apparent from equations (1) and (2), gain(G)<gain_low(G) holds, and the correction degree of the low-luminance region is different from the correction degree of the intermediate/high-luminance region.

In step S164, the determination unit 210 determines which of the correction regions includes the target pixel of the inspection image. More specifically, the determination unit 210 acquires the pixel value of one pixel of the inspection image, and determines, with reference to the correction region determination map created in step S15 in the RAM 102, which of the first color correction unit 205 and the second color correction unit 206 is used to perform correction. If the pixel value in the correction region determination map is 0 indicating the intermediate/high-luminance region, the determination unit 210 advances to processing in step S165. If the pixel value in the correction region determination map is 1 indicating the low-luminance region, the determination unit 210 advances to processing in step S166. Note that if the pixel value in the correction region determination map is not 0 or 1, that is, the pixel has a large noise amount and is not a correction target, the determination unit 210 may execute processing in step S167 without executing the processes in steps S165 and S166.

In step S165, the first color correction unit 205 corrects the luminance value of the pixel in the intermediate/high-luminance region of the inspection image using the first color correction condition calculated in step S163 by:

$$\begin{matrix}{R}^{′} = R \times gain ( G ) \\ {G}^{′} = G \times gain ( G ) \\ {B}^{′} = B \times gain ( G )\end{matrix} \qquad ( 3 )$$

(R, G, B) are the pixel values of the image before correction, and (R′, G′, B′) are the pixel values of the image after correction.

In step S166, the second color correction unit 206 corrects the luminance value of the pixel in the low-luminance region of the inspection image using the second color correction condition calculated in step S163 by:

$$\begin{matrix}{R}^{′} = R \times gain\_low ( G ) \\ {G}^{′} = G \times gain\_low ( G ) \\ {B}^{′} = B \times gain\_low ( G )\end{matrix} \qquad ( 4 )$$

In step S167, the determination unit 210 determines whether the first color correction or the second color correction has been performed for all the pixels of the inspection image. If one of the color correction processes has been performed for all the pixels, the determination unit 210 advances to processing in step S168. If one of the color correction processes has not been performed for all the pixels, the determination unit 210 returns to the processing in step S164.

In step S168, the noise reduction unit 209 calculates a noise amount using a statistic value such as a standard deviation or variance of the pixel values in a predetermined window size with, as the center, the target pixel of at least one of the reference image and the read image. Note that the noise reduction unit 209 may calculate PSNR by pairing the inspection images before and after correction without using the above-described statistic value, and calculate the PSNR as a noise amount.

In step S169, the noise reduction unit 209 determines whether the noise amount calculated in step S168 is larger than a preset noise threshold. If the noise amount is larger than the noise threshold, the noise reduction unit 209 advances to processing in step S170. If the noise amount is equal to or smaller than the noise threshold, the noise reduction unit 209 advances to processing in step S171.

In step S170, the noise reduction unit 209 performs noise reduction processing for a pixel whose noise amount is larger than the noise threshold. For example, the noise reduction unit 209 performs, as noise reduction processing, smoothing filter processing using an averaging filter or Gaussian filter.

In step S171, the noise reduction unit 209 saves the corrected image in the RAM 102, and ends the processing.

Note that in step S16, the image processing apparatus 100 may omit the noise reduction processing in steps S168 to S170, save the image corrected in steps S161 to S167 in the RAM 102, and end the processing.

This embodiment has explained the luminance value correction processing using the gain value that sets paper white as a target value but a correction method is not limited to this. For example, a plurality of target values may be set for respective gray tones in addition to paper white, an LUT for correcting a tone to the target value may be created as a correction table, and the first color correction condition and the second color correction condition may be set to correct the tone of the luminance value of the inspection image, thereby performing correction.

As described above, the image processing apparatus 100 of the first embodiment corrects a pixel value (luminance value) in at least the low-luminance region of the inspection image, and inspects a defect. This allows the image processing apparatus 100 to reduce cumbersome setting for inspecting a defect. For example, the image processing apparatus 100 sets a parameter such as an inspection threshold in accordance with inspection of a defect in the intermediate/high-luminance region, and increases the luminance value of the pixel in the low-luminance region to be close to the luminance value of the pixel in the intermediate/high-luminance region, thereby making it possible to inspect defects in both the regions by one inspection threshold.

The image processing apparatus 100 corrects the luminance value of the pixel in the intermediate/high-luminance region of the inspection image using a color correction condition different from that for correcting the pixel in the low-luminance region. This allows the image processing apparatus 100 to more accurately inspect a defect in the intermediate/high-luminance region.

The image processing apparatus 100 sets a different gain representing the correction degree for each of the low-luminance region and the intermediate/high-luminance region. This allows the image processing apparatus 100 to execute more appropriate correction for each of the low-luminance region and the intermediate/high-luminance region to improve the inspection accuracy of a defect.

The image processing apparatus 100 sets gains as the correction conditions of the pixel values in the low-luminance region and the intermediate/high-luminance region based on the histogram of the pixel values of the inspection image. This allows the image processing apparatus 100 to appropriately set the correction condition for each inspection image.

Since the image processing apparatus 100 inspects a defect by reducing noise in the corrected inspection image, it is possible to further improve the inspection accuracy of the defect.

Since the image processing apparatus 100 performs correction to increase the luminance value of the pixel in the low-luminance region where it is difficult to inspect a defect, it is possible to improve the inspection accuracy of a defect even in the low-luminance region.

Since the image processing apparatus 100 sets the correction degree of the luminance value of the pixel in the low-luminance region to be higher than the correction degree in the intermediate/high-luminance region, it is possible to make the luminance value in the low-luminance region closer to the luminance value in the intermediate/high-luminance region. This allows the image processing apparatus 100 to more accurately inspect a defect even by one inspection threshold.

### Second Embodiment

The first embodiment has explained the method of dividing an inspection image into two regions of a low-luminance region and an intermediate/high-luminance region, executing second color correction for the low-luminance region, executing first color correction for the intermediate/high-luminance region, and inspecting the presence/absence of a defect using the image having undergone the color correction. The second embodiment assumes a case where in inspection of a printed product formed by a plurality of layers such as a label sheet, if a base material on which printing is executed is a transparent material or thin material, the color of release paper or backing paper as a layer under the base material is seen through the base material and thus a defect on the printed product cannot appropriately be inspected. In this case, a read image acquired by a reading device is darker than it looks, the luminance value or contrast of the image is insufficient when performing alignment processing or defect detection processing, and thus it may be impossible to perform inspection with desired accuracy. A method of improving readability of characters using, for example, white ink or white toner on a film to satisfactorily reproduce the image quality of the label may be executed. In this case, since the luminance value does not decrease in a region covered with white ink or white toner, if the luminance value is uniformly corrected in accordance with a region not covered with white ink or white toner, a highlight-detail loss or a shadow-detail loss in the high-luminance region occurs, thereby making it impossible to perform appropriate inspection. To solve this problem, the second embodiment will describe a method of deciding a region to be applied with luminance value correction in accordance with whether to form an underlayer by, for example, white ink or white toner different from a printing layer, and inspecting the presence/absence of a defect using the image after color correction.

### <Operation of Image Processing Apparatus 100 in Step S26>

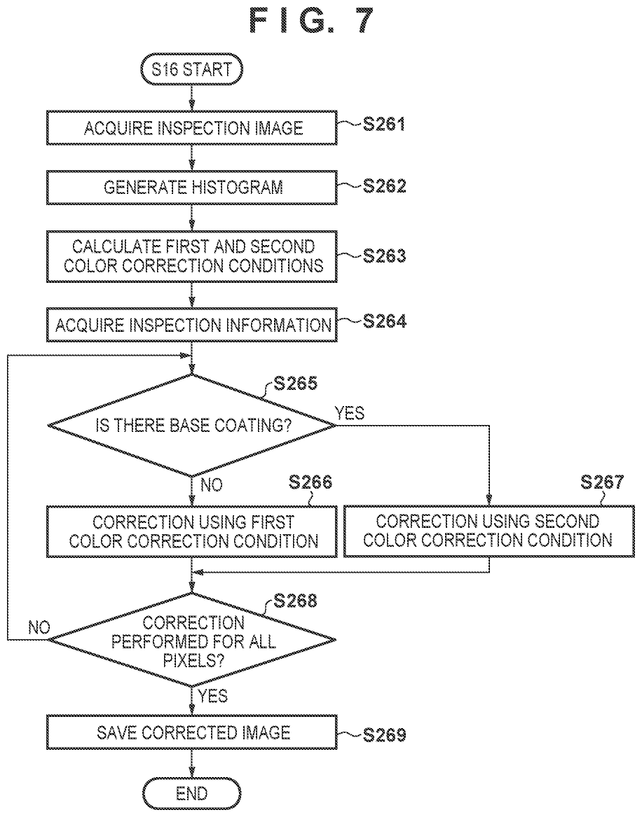

The second embodiment will describe processing in step S16 different from the first embodiment with reference to FIG. 7. The remaining processes are the same as in the first embodiment and a description thereof will be omitted. FIG. 7 is a flowchart of processing in step S16 by the image processing apparatus 100 according to the second embodiment.

In step S261, a region decision unit 204 acquires, as an inspection image, a reference image and a read image, similar to the processing in step S161.

In step S262, the region decision unit 204 creates a histogram, similar to the processing in step S162.

In step S263, a first color correction unit 205 and a second color correction unit 206 calculate first and second color correction conditions, similar to the processing in step S163.

In step S264, an inspection information acquisition unit 203 acquires sheet information to be used as inspection information.

In step S265, a determination unit 210 determines whether base coating processing such as top-coating or under-coating has been performed for the inspection target image. If the base coating processing has been performed, the determination unit 210 advances to processing in step S266. If the base coating processing has not been performed, the determination unit 210 advances to processing in step S267. Note that the determination unit 210 determines the presence/absence of the base coating processing by checking whether the document data of the inspection image includes data other than printing colors. For example, if the document data includes, in the image layer of the document data, data representing an output using white ink in addition to C, M, Y, and K representing printing colors, the determination unit 210 determines that the base coating processing is performed. If the document data does not include the data, the determination unit 210 determines that the base coating processing is not performed. Therefore, in the case of a region where white ink is output with reference to the document data, the determination unit 210 advances to processing in step S266. In the case of a region where white ink is not output, the determination unit 210 advances to processing in step S267. Note that in this embodiment, white ink or white toner has been exemplified as an example of base coating processing. However, for example, the above-described determination method is also applicable to a case where special toner or ink of clear, gold, silver, or the like is provided in a printing apparatus and a printed product is formed by a multilayer structure. By using special toner or ink of gold, silver, clear, or the like in a top-coating layer above the printing layer, a high-quality feel or a metallic expression can be given to the label, and the determination unit 210 may decide the presence/absence of execution of luminance value correction in accordance with a region where the toner or ink is printed.

In step S266, the first color correction unit 205 corrects the inspection image using the first color correction. For example, the first color correction unit 205 considers that the luminance value of a pixel in a region having undergone the base coating processing does not decrease, sets 1 as a correction coefficient, and outputs an image without executing the first color correction.

In step S267, the second color correction unit 206 corrects the inspection image using the second color correction. The processing in step S267 is the same as that in step S166. The second color correction unit 206 acquires a target value corresponding to the sheet information acquired in step S264, and performs luminance value correction so that the luminance value of the inspection image becomes equal to the target value.

In step S268, the determination unit 210 determines whether correction has been performed for all the pixels of the inspection image. If correction has been performed for all the pixels, the determination unit 210 advances to processing in step S269. If correction has not been performed for all the pixels, the determination unit 210 returns to the processing in step S265, and continues the processing.

If it is determined that correction has been performed for all the pixels of the inspection image, the determination unit 210 saves, in step S269, the corrected image in a RAM 102, and ends the processing.

As described above, in the method of the second embodiment, by executing color correction for each region in accordance with the presence/absence of base coating processing, it is possible to accurately detect a defect on a printed product without using a cumbersome adjustment operation such as setting of an inspection region and an inspection level in accordance with an image content. If a base material of a transparent material is used in label printing, the color reproduction characteristic changes between a region covered with white ink or white toner as base coating processing and a region not covered with white ink or white toner, and it is thus necessary to manually adjust the region designation and the setting of the inspection level in accordance with the covered region. By using the method of the second embodiment, manual adjustment according to the covered region becomes unnecessary, and it is possible to automatically, accurately detect a defect on a printed product.

### Third Embodiment

Each of the first and second embodiments has explained the method of dividing an inspection image into regions and performing color correction for each region. The third embodiment will describe a method of performing first color correction and second color correction for all pixels of an inspection image, executing inspection for each of the inspection images after the correction processes, and determining the presence/absence of a defect based on both of an inspection result obtained using a first color correction image and an inspection result obtained using a second color correction image.

### Operation of Image Processing Apparatus 100 in Third Embodiment

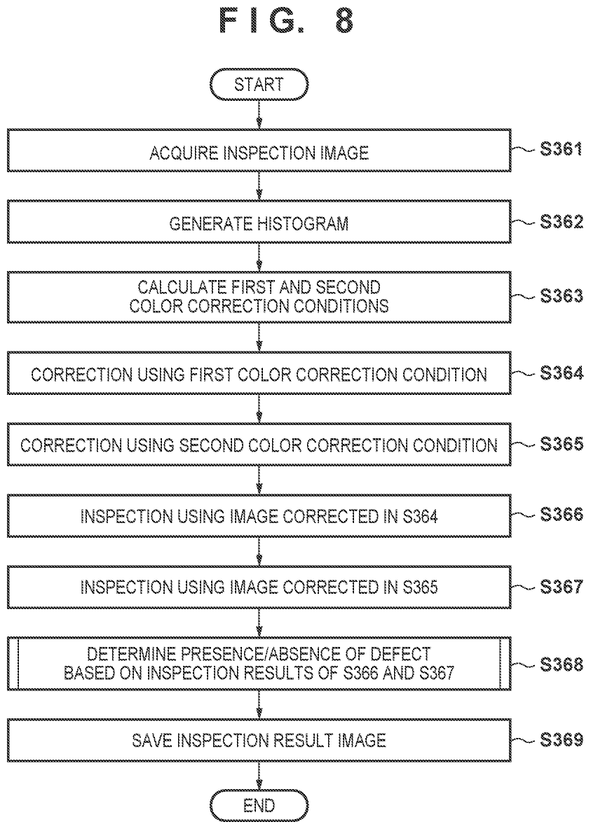

FIG. 8 is a flowchart illustrating the procedure of an image processing method executed by the image processing apparatus 100.

In step S361, a region decision unit 204 acquires a reference image and a read image as an inspection image.

In step S362, the region decision unit 204 creates a histogram, similar to the processing in step S162.

In step S363, a first color correction unit 205 and a second color correction unit 206 calculate a first color correction condition and a second color correction condition, similar to the processing in step S163.

In step S364, the first color correction unit 205 corrects the reference image and the read image using the first color correction condition calculated in step S363.

In step S365, the second color correction unit 206 corrects the reference image and the read image using the second color correction condition calculated in step S363.

In step S366, an inspection unit 207 performs inspection processing using the inspection image corrected in step S364, thereby generating a first inspection result. The inspection processing is the same as the processing in step S17.

In step S367, the inspection unit 207 performs inspection processing using the inspection image corrected in step S365, thereby generating a second inspection result. The inspection processing is the same as the processing in step S17.

In step S368, the inspection unit 207 determines the presence/absence of a defect based on the inspection results obtained in steps S366 and S367. Details of the processing in step S368 will be described later.

In step S369, a display control unit 208 saves an inspection result image in the RAM 102, and ends the processing.

### <Operation of Image Processing Apparatus 100 in Step S368>

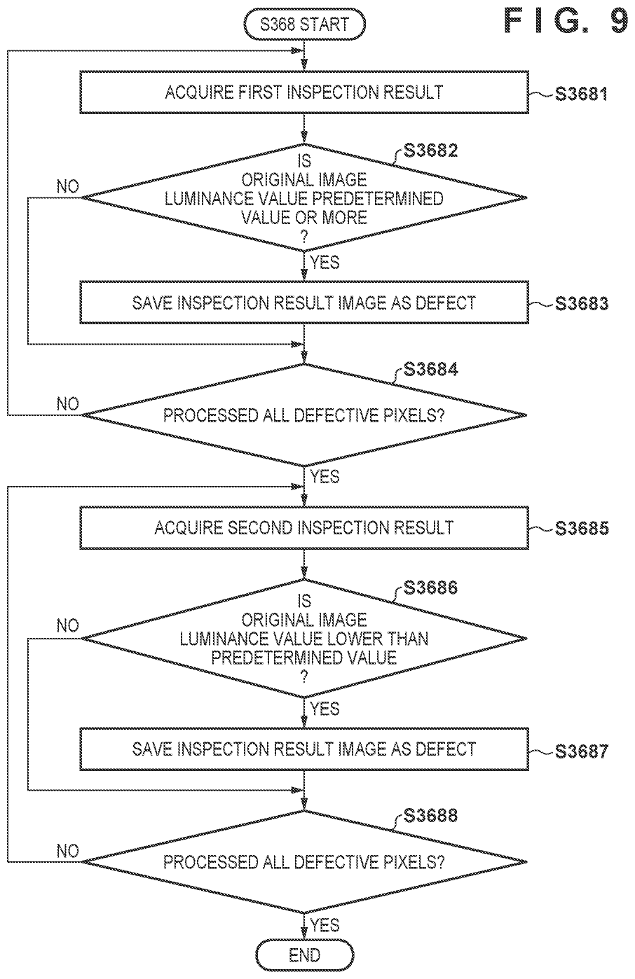

In step S368, the inspection unit 207 determines the presence/absence of a defect by integrating the inspection results obtained in steps S366 and S367 with reference to the luminance values of the image before correction. With respect to the inspection result of the inspection image corrected using the first color correction condition in step S366, the correction degree of the luminance values is low and the reliability of the inspection result of a dark region is low. Therefore, the inspection unit 207 adopts a defect in a region (intermediate/high-luminance region) having a value equal to or higher than a predetermined determination threshold with reference to the luminance values of the inspection image before correction. With respect to the inspection result of the inspection image corrected using the second color correction condition in step S367, the correction degree of the luminance values is high and the reliability of the inspection result of a bright region is low. Therefore, the inspection unit 207 performs processing of adopting a defect in a region (low-luminance region) having a value lower than the predetermined determination threshold with reference to the luminance values of the original image before correction. FIG. 9 is a flowchart illustrating the procedure of the processing in step S368 executed by the inspection unit 207.

In step S3681, the inspection unit 207 acquires the first inspection result obtained in step S366.

In step S3682, the inspection unit 207 acquires one of the pixels each determined as a defect from the inspection result image acquired in step S3681, and refers to the luminance value of the inspection image before correction corresponding to the coordinates of the pixel. If the referred luminance value is equal to or higher than the predetermined determination threshold, the inspection unit 207 advances to processing in step S3683. If the referred luminance value is lower than the predetermined determination threshold, the inspection unit 207 advances to processing in step S3684.

In step S3683, the inspection unit 207 stores a defect flag in the image with respect to a pixel determined to have a value equal to or higher than the predetermined determination threshold in step S3682, similar to the defect map described in step S18, and saves the inspection result image in the RAM 102.

In step S3684, the inspection unit 207 determines whether the processing has been performed for all the pixels acquired in step S3681 and each indicating a defect. If the processing has been performed for all the pixels, the inspection unit 207 advances to processing in step S3685. If the processing has not been performed for all the pixels, the inspection unit 207 returns to the processing in step S3681, and continues the processing.

In step S3685, the inspection unit 207 acquires the second inspection result obtained in step S367.

In step S3686, the inspection unit 207 acquires one pixel among the pixels each determined as a defect from the inspection result image acquired in step S3685, and refers to the luminance value of the original image before correction corresponding to the coordinates of the pixel. If the referred luminance value is lower than the predetermined determination threshold, the inspection unit 207 advances to processing in step S3687. If the referred luminance value is equal to or higher than the predetermined determination threshold, the inspection unit 207 advances to processing in step S3688.

In step S3687, the inspection unit 207 saves, in the RAM 102, the inspection result image in which a defect flag is stored in a pixel determined to have a value lower than the predetermined determination threshold in step S3686, similar to the defect map described in step S18.

In step S3688, the inspection unit 207 determines whether the processing has been performed for all the pixels acquired in step S3681 and each indicating a defect. If the processing has been performed for all the pixels, the inspection unit 207 ends the processing. If the processing has not been performed for all the pixels, the inspection unit 207 returns to the processing in step S3685, and continues the processing.

As described above, the image processing apparatus 100 of the third embodiment executes correction processes based on different color correction conditions for the inspection image, and determines a defect based on both inspection results obtained by performing inspection using different corrected images. This allows the image processing apparatus 100 to accurately detect a defect on a printed product without performing correction for each region. The image processing apparatus 100 can determine a defect with a small calculation amount by not performing correction for each region, thereby obtaining an effect of shortening the processing time and reducing the hardware cost of an inspection system. In addition, depending on a pattern, there is a problem regarding whether the image processing apparatus 100 can accurately divide the boundary value of each region in processing for each region. However, in the method of the third embodiment, it is possible to perform inspection independently of the processing accuracy of region determination, and it is thus possible to accurately detect a defect on a printed product.

### Other Embodiments: Color Correction Processing

Each of the first to third embodiments has explained a method of performing luminance value correction based on a luminance value of an image as color correction processing. However, color correction may be executed based on a chromaticity value of an inspection image. Since a defect detection parameter is often set based on a sheet, in a case where color cast partially occurs in the inspection image or a case where a content includes a high-chroma color, it may be impossible to perform processing using a uniform parameter due to a high chroma value of the inspection image. Therefore, a chroma histogram of the inspection image may be created, the inspection image may be divided into a low-chroma region and an intermediate-chroma region and high-chroma region (to be referred to as an intermediate/high-chroma region hereinafter), and preprocessing may be executed to perform chromaticity correction so as to decrease the chroma value of the pixel of the inspection image in the intermediate/high-chroma region or set the chromaticity value of white balance to be a paper white standard value, thereby inspecting a defect. Note that as described in the first embodiment, color noise may be calculated as a noise amount with respect to noise at the time of correction, and compared with a predetermined noise threshold, thereby executing noise reduction processing.

### Other Embodiments: Display Unit

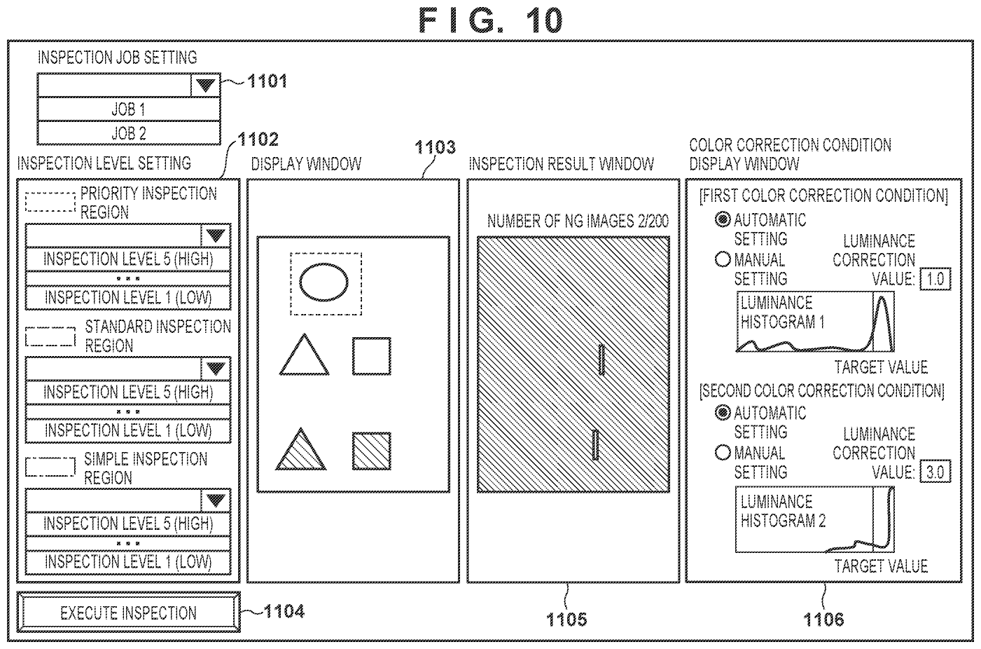

In the first embodiment, the display control unit 208 displays the inspection result on the inspection result window 1105. However, the inspection result may discriminately be displayed so that the user can recognize whether the inspection result is a result of performing correction by the first color correction unit or a result of performing correction by the second color correction unit. For example, a caption clearly indicating whether the inspection result is the result obtained by the first color correction unit or the result obtained by the second color correction unit may be added beside a detected defect. A defect target pixel may discriminately be displayed by expressing, by pixel values (255, 255, 0), the result obtained by the first color correction unit and expressing, by pixel values (0, 255, 255), the result obtained by the second color correction unit. The first color correction condition and the second color correction condition may be settable in the display control unit 208. For example, a color correction condition display window 1106 may further be provided, as shown in FIG. 10, the correction coefficient calculated in the first embodiment may be displayed on the color correction condition display window 1106, and the user may be able to manually set the correction coefficient. The histogram of the pixel values of the corrected image and the correction target value may be displayed on the color correction condition display window 1106, and a user set value may be acquired by guiding, in a case where upper 5% of the pixel values of the histogram are smaller than the correction target value, to manually set the correction value of the luminance value to be larger than an automatically calculated value.

In each of the above-described embodiments, the image processing apparatus 100 including the first color correction unit 205 and the second color correction unit 206 has been exemplified. However, one of these correction units may be omitted. For example, if the luminance value of the pixel in the intermediate/high-luminance region is not corrected, the first color correction unit 205 may be omitted. The configuration of the image processing apparatus 100 is not limited to the above-described configuration. For example, the image reading device 105 may be an apparatus separated from the image processing apparatus 100. The image processing apparatus 100 may have, for example, a configuration without the noise reduction unit 209. In this case, the noise reduction processing by the noise reduction unit 209 is omitted.

Each of the above-described embodiments has explained an example in which if the noise amount of a pixel is larger than a noise threshold, the region decision unit 204 does not correct the pixel by excluding the pixel from the correction region, that is, by excluding the pixel from the correction target. However, the processing for the pixel is not limited to this. For example, the region decision unit 204 may perform correction for a pixel with a large noise amount by setting the correction degree lower than that for a pixel with a small noise amount. With respect to a pixel whose luminance value is lower than the determination threshold and whose noise amount is larger than the noise threshold, the region decision unit 204 may exclude the pixel from the correction target or decrease a correction coefficient to decrease the correction degree by the color correction unit 205 or 206.

Each of the above-described embodiments has explained an example in which one noise threshold is used but a plurality of noise thresholds may be set. For example, the noise threshold may be set in accordance with the sensitivity at which a defect is detected. More specifically, the noise threshold may be set smaller as the sensitivity at which a defect is detected is higher. Especially in a dark portion where a luminance value is low, for example, a luminance value is lower than the determination threshold, the noise threshold may be set smaller as the sensitivity at which a defect is detected is higher.

In the above-described first embodiment, correction is performed by dividing an image into two regions of a low-luminance region and an intermediate/high-luminance region. However, the number of correction regions is not limited to two. The correction region may be divided into three or more regions and a correction condition may be set for each region to perform correction.

### Other Embodiments

The present invention can also be implemented by supplying a program configured to implement one or more functions of the above-described embodiments to a system or an apparatus via a network or a storage medium and causing one or more processers in the computer of the system or the apparatus to read out and execute the program. This can also be implemented by a circuit (for example, an ASIC) that implements one or more functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-153906, filed Sep. 20, 2023 which is hereby incorporated by reference herein in its entirety.

What is claimed is:

1. An image processing apparatus comprising:
a reference image acquisition unit configured to acquire a reference image as a reference of inspection of a printed product;
a read image acquisition unit configured to acquire a read image obtained by reading the printed product;
a correction unit configured to correct a color of a first region using a first correction condition and correct a color of a second region using a second correction condition in the reference image and the read image; and
an inspection unit configured to inspect the printed product based on the color of the first region corrected using the first correction condition and the color of the second region corrected using the second correction condition.

2. The apparatus according to claim 1, wherein the correction unit corrects, using the first correction condition, the color of the first region where a pixel value is smaller than a threshold, and corrects, using the second correction condition, the color of the second region where a pixel value is not smaller than the threshold.

3. The apparatus according to claim 1, wherein the correction unit corrects a luminance value in the first region using the first correction condition, and corrects a luminance value in the second region using the second correction condition.

4. The apparatus according to claim 3, wherein the correction unit performs correction to increase the luminance value in the first region.

5. The apparatus according to claim 1, wherein the correction unit corrects the color of the first region using the first correction condition, and corrects the color of the second region using the second correction condition different in correction degree from the first correction condition.

6. The apparatus according to claim 5, wherein the correction unit corrects the color of the first region using the first correction condition including the correction degree higher than the correction degree of the second correction condition.

7. The apparatus according to claim 1, wherein the correction unit sets the first correction condition and the second correction condition based on a histogram of pixel values of at least one of the reference image and the read image.

8. The apparatus according to claim 1, further comprising a noise reduction unit configured to reduce noise in a case where a noise amount of a pixel value of at least one of the corrected reference image and the corrected read image is larger than a predetermined threshold.

9. The apparatus according to claim 1, wherein the correction unit corrects pixel values of pixels in the first region and the second region based on a correction table for correcting tones in the first region and the second region.

10. The apparatus according to claim 1, wherein the correction unit corrects a chroma value in the first region using the first correction condition, and corrects a chroma value in the second region using the second correction condition.

11. The apparatus according to claim 1, further comprising a region decision unit configured to decide the first region based on a pixel value of a pixel of at least one of the reference image and the read image,
wherein the inspection unit inspects the printed product based on the color corrected using the first correction condition in the decided first region.

12. An image processing apparatus comprising:
a reference image acquisition unit configured to acquire a reference image as a reference of inspection of a printed product;
a read image acquisition unit configured to acquire a read image obtained by reading the printed product;
a correction unit configured to correct colors of the reference image and the read image using a first correction condition and a second correction condition; and
an inspection unit configured to inspect the printed product based on the colors of the reference image and the read image corrected using the first correction condition and the colors of the reference image and the read image corrected using the second correction condition.

13. An image processing method comprising:
acquiring a reference image as a reference of inspection of a printed product;
acquiring a read image obtained by reading the printed product;
correcting a color of a first region using a first correction condition and correct a color of a second region using a second correction condition in the reference image and the read image; and
inspecting the printed product based on the color of the first region corrected using the first correction condition and the color of the second region corrected using the second correction condition.

14. An image processing method comprising:
acquiring a reference image as a reference of inspection of a printed product;
acquiring a read image obtained by reading the printed product;
correcting colors of the reference image and the read image using a first correction condition and a second correction condition; and
inspecting the printed product based on the colors of the reference image and the read image corrected using the first correction condition and the colors of the reference image and the read image corrected using the second correction condition.

15. A non-transitory computer-readable storage medium storing a computer program for causing, when loaded and executed by a computer, the computer to:
acquire a reference image as a reference of inspection of a printed product;
acquire a read image obtained by reading the printed product;
correct a color of a first region using a first correction condition and correct a color of a second region using a second correction condition in the reference image and the read image; and
inspect the printed product based on the color of the first region corrected using the first correction condition and the color of the second region corrected using the second correction condition.

16. A non-transitory computer-readable storage medium storing a computer program for causing, when loaded and executed by a computer, the computer to:
acquire a reference image as a reference of inspection of a printed product;
acquire a read image obtained by reading the printed product;
correct colors of the reference image and the read image using a first correction condition and a second correction condition; and
inspect the printed product based on the colors of the reference image and the read image corrected using the first correction condition and the colors of the reference image and the read image corrected using the second correction condition.
